(19) United States
(12) Patent Application Publication
(10) Pub. No.: US 2013/0292035 A1
(43) Pub. Date: Nov. 7, 2013

(54) Methods For Routing An Optical Fiber Or Cable Inside A Building Or Living Unit of Customer Premises

(71) Applicant: OFS Fitel, LLC, Norcross, GA (US)

(72) Inventors: Paul R. Dickinson, Johns Creek, GA (US); John George, Cumming, GA (US); Daniel Hendrickson, Roswell, GA (US); Jimmy Joy, Lawrenceville, GA (US)

(21) Appl. No.: 13/932,440

(22) Filed: Jul. 1, 2013

Related U.S. Application Data
(62) Division of application No. 13/357,305, filed on Jan. 24, 2012.

(51) Int. Cl. B32B 37/14

(52) U.S. Cl. CPC B32B 37/14
USPC 156/71

(57) ABSTRACT

Methods for routing an optical fiber over a desired span on a structural surface at a given premises are provided. When the optical fiber is unwound from a container, the optical fiber attaches to the structural surface by an adhesive material. The adhesive material can be applied along the desired span before, during, or after the optical fiber is routed over the desired span.

### CROSS-REFERENCE TO RELATED APPLICATIONS

The present application is a divisional of co-pending United States Non-provisional patent application Ser. No. 13/357,305 filed on Jan. 24, 2012, entitled “APPARATUS AND METHODS FOR ROUTING AN OPTICAL FIBER OR CABLE INSIDE A BUILDING OR LIVING UNIT OF CUSTOMER PREMISES”, which is owned by the assignee of the present application, and which is incorporated herein by reference in its entirety. Also, co-pending PCT Application No. PCT/11/44419 filed on Jul. 19, 2011, entitled “OPTICAL FIBER INSTALLATION AT CUSTOMER PREMISES”, which is owned by the assignee of the present application is incorporated herein by reference in its entirety.

### BACKGROUND OF THE INVENTION

1. Field of the Invention

This invention relates to the installation of an optical fiber or cable over a desired span at a customer premises.

2. Discussion of the Known Art

U.S. Pat. No. 7,266,283 (Sep. 4, 2007) describes fiber optic storing and dispensing apparatus. The patented apparatus includes a casing containing a rotatable spool, wherein a long and a short length of a fiber optic jumper cable are coiled in corresponding grooves on the spool. Both ends of the cable are coupled to connectors. One length of the jumper cable is extendable a certain distance from the casing to establish a first connection at one end of the cable. The other length is then manually uncoiled from the spool for making a second connection at the opposite end of the cable. The patent notes (col. 5, lines 32-39) that once the jumper cable is connected at both ends, the casing may be mounted on a junction box via magnetic strips to provide a removable support for the casing.

U.S. Patent Application Pub. No. 2008/0187276 (Aug. 7, 2008) discloses a flexible optical fiber tape including an adhesive substrate strip, and at least one optical fiber maintained by the strip. According to the patent, the strip may be adhered along with the fiber to a wall, floor, or ceiling in indoor applications.

As far as is known, no tool, system or technique has been disclosed that will enable an installer to route an optical fiber or cable and simultaneously apply adhesive to adhere the optical fiber or cable on a surface.

### SUMMARY OF THE INVENTION

According to the invention, a tool for routing an optical fiber or cable over a desired span on a visible supporting surface at a given premises, includes a hand-held gun device with a cartridge, and a reel or spool is attached to the gun device or to the cartridge for storing a length of the fiber or cable to be routed. The cartridge dispenses an adhesive material on the fiber when the fiber is unwound from the spool during use of the tool. A fiber-routing applicator is disposed at the distal end of the cartridge. The routing applicator is configured to receive the optical fiber from the spool and to enable both adhesive material and fiber to be simultaneously dispensed as the applicator travels over the desired span.

According to another aspect of the invention, a tool for routing an optical fiber or cable over a desired span on a visible supporting surface at a given premises, includes a cartridge having a first nozzle, a spool and a device attached to the first nozzle. The cartridge contains adhesive material that is dispensed from the first nozzle the distal end of the cartridge. The spool contains a length of the optical fiber to be routed over the desired span, and the spool is attached to the cartridge. The device attached to the first nozzle at the distal end of the cartridge is configured to receive the optical fiber from the spool and to enable both adhesive material and fiber to be simultaneously dispensed as the cartridge travels over the desired span.

According to another aspect of the invention, a method for routing an optical fiber over a desired span on a structural surface inside a building or living unit comprises the steps of: storing a length of the optical fiber in a container; applying a bead of adhesive material to at least a portion of the desired span; and removing the length of optical fiber from the container and pressing same into the bead of adhesive material.

According to another aspect of the invention, a method for routing an optical fiber over a desired span on a structural surface inside a building or living unit comprises the steps of: storing a length of the optical fiber in a container; removing the length of optical fiber from the container and attaching same to the structural surface at two or more points along the desired span; and applying a bead of adhesive material to the optical fiber between the points of attachment.

According to another aspect of the invention, a method for routing an optical fiber along a desired path on a structural surface between first and second locations within a building or living unit comprises the steps of: storing the optical fiber within a fiber storage module, said fiber being wound on a spool within the module and terminated at each end with an optical connector; applying a bead of adhesive material along a portion of the desired path; unwinding a portion of the stored fiber from the fiber storage module; positioning one of the connectors at the first location for connection to a source of incoming optical signals; pressing the unwound fiber into the bead of adhesive material; and attaching the fiber storage module to a surface at the second location within the building or living unit.

For a better understanding of the invention, reference is made to the following description taken in conjunction with the accompanying drawing and the appended claims.

### BRIEF DESCRIPTION OF THE DRAWING

In the drawing:

FIG. 1 illustrates a first embodiment of a fiber optic cable routing system according to the invention;

FIG. 2 illustrates a second embodiment of the inventive fiber optic cable routing system including an applicator tool;

FIG. 3 shows one of two fiber optic cable termination boxes or “rosettes” that may be used with the applicator tool in FIG. 2;

FIG. 4 depicts two of the termination boxes in FIG. 3 removably fastened against corresponding side end flanges of an optical fiber or cable storage spool;

FIG. 5 shows one of the termination boxes in FIG. 4 being removed from the storage spool;

FIG. 6 shows the removed termination box in FIG. 5 fastened at one end of a desired path an over which the fiber is to be routed and adhered on an exposed surface;

FIG. 7 shows the fiber being routed over the surface using the applicator tool;

FIG. 8 shows the fiber routed to the other end of the path, and the other termination box and storage spool fastened to the surface at the other end of the path;

FIG. 9 depicts the applicator tool in FIG. 2, including a mount for supporting an optical fiber or cable storage spool with an optionally attached cable termination box or rosette;

FIG. 10 shows another tool for routing an optical fiber or a cable over a desired span on a structural surface at a given premises;

FIG. 11 shows an embodiment to attach the spool to a gun device;

FIG. 12 shows yet another tool for routing an optical fiber or a cable over a desired span on a structural surface at a given premises;

FIG. 13 shows a cross-sectional view of the tool in FIG. 12 with respect to a line A;

FIG. 14 shows an embodiment of a first nozzle at the distal end of the cartridge;

FIG. 15 shows one method to urge the fiber against a structural surface when both adhesive material and fiber are simultaneously dispensed;

FIG. 16 shows an embodiment of a second nozzle, which attaches to the first nozzle at the distal end of the cartridge;

FIG. 17 shows an embodiment of a guide clamp attached to the first nozzle of the cartilage;

FIG. 18 shows another view of the guide clamp shown in FIG. 17;

FIG. 19 shows a fiber storage device, which stores the fiber to be routed over a desired span on a structural surface inside a building or living unit;

FIG. 20 shows a spool inside of the fiber storage device;

FIG. 21 shows an outside right-angle bend manager;

FIG. 22 shows an inside right-angle bend manager; and

FIG. 23 shows a caulk finishing tool pressing a fiber into the bead of adhesive material.

### DETAILED DESCRIPTION OF THE INVENTION

The inventive system allows an optical fiber or cable to be routed along a structural surface (e.g., a wall or ceiling) associated with a living unit at a given premises, using a limited amount of hardware and with little if any visible profile. Unless otherwise stated, the terms “optical fiber” and “cable” are used interchangeably herein to connote one or more lengths of optical fibers, each of which may or may not be protectively enclosed by an outer cable jacket. Further, as used herein, the term “structural surface” refers to any visible or exposed surface of the walls, ceiling, or floor associated with a given living unit (e.g., a room or an office) at a customer premises.

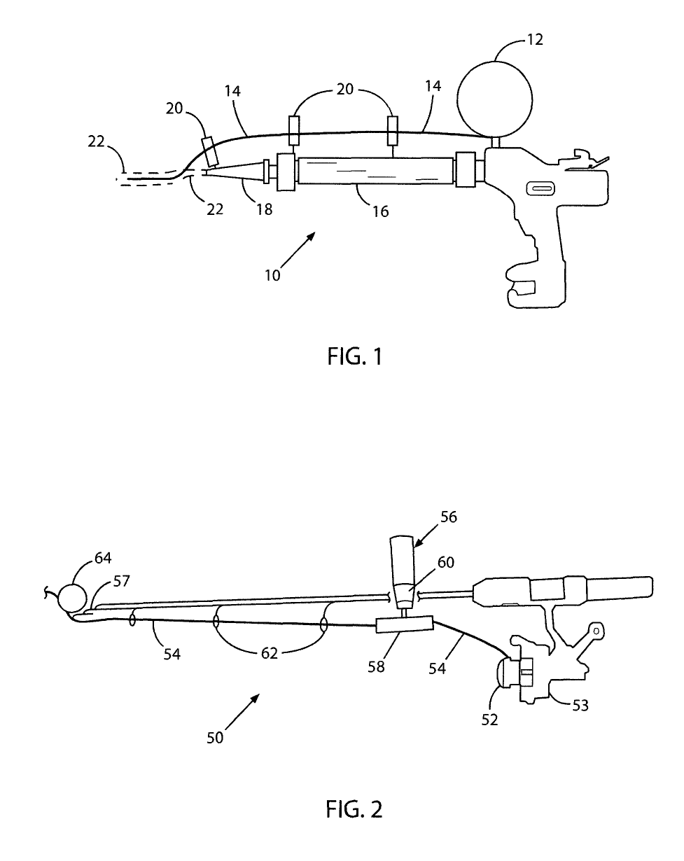

In FIG. 1, a hand-held tool gun device 10 has a construction that is generally the same or similar to a conventional mechanical or electrically powered caulking gun. The device 10 also includes a reel or spool 12 on which a length of an optical fiber or cable 14 is wound. The spool 12 is mounted near a proximal trigger end of the gun device 10, so that the fiber 14 unwinds from the spool while it is being routed by the device over a desired span on a wall, ceiling, or other structural surface at a user's premises. The opposite ends of the fiber 14 may be unterminated, or terminated at one or both ends with specified connectors. A replaceable cartridge 16 containing a caulking or an adhesive is arranged for insertion in the gun device 10. The cartridge 16 has an applicator tip 18 that projects from a distal end of the gun device 10 when the cartridge 16 is operatively inserted in the device.

The spool 12 may also have an optical termination unit or box (also known as a “rosette”) detachably fastened on one side of the spool. See the fiber storage spool 202 with attached rosette 208 in the embodiment of FIGS. 5 to 9. In such an arrangement, the spool 12 and the rosette may be mounted on or within a cradle or mount that is attached to the gun device 10, so that the fiber 14 pays out or unwinds from the spool 12 while the fiber is being routed by the device 10 over a desired span.

The fiber 14 may comprise, for example but not be limited to, a 200 μm optical fiber, a 250 μm bare optical fiber, a 500 μm tight buffered fiber, a 900 μm tight buffered fiber, or cordage comprising a buffered fiber covered with aramid yarn and an outer jacket. Preferably, the diameter of the cordage is 900 μm, 1.6 mm, 2 mm, 3 mm or 4.8 mm.

The spool 12 may be constructed and arranged in a known manner for easy mounting on the gun device 10, and for quick removal when the wound fiber 14 is exhausted or when another spool containing a different type of fiber or cable is desired. The fixture for mounting spool 12 on gun device 10 may allow spool 12 to be re-positioned on the gun device 10 prior to or during the installation process to bypass obstacles to the passage of the gun device 10/spool 12 assembly. One or more rings or loops 20 are preferably fixed at intervals along the length of the cartridge 16 or other portion of the device body, for guiding the fiber 14 as it unwinds from the spool 12 toward the applicator tip 18.

During use of the gun device 10, the fiber 14 unwinds or pays out from the spool 12 to be deposited on a structural surface over the desired span, together with the caulking or the adhesive 22 from the device cartridge 16. The applicator tip 18 and the guide rings 20 are dimensioned and arranged so that the fiber 14 is guided along the desired pathway and the adhesive 22 will flow over the fiber and bind the fiber to the surface, while providing strain relief for the fiber at the same time.

The cartridge 16 may contain and dispense a commercially available silicone or acrylic based caulking. If it is necessary to recess the fiber or cable 14 below a structural surface (for example, the surface may be a living room ceiling or a sheet rock wall), the gun device 10 may also be provided with a cutting blade arranged at the distal end of the device for forming a furrow or a trough in the surface, in situ. This would allow the device to lay the fiber 14 in the cut trough before the caulking or adhesive 22 from the applicator tip 18 is deposited over the fiber.

Alternatively, the fiber 14 may be pre-coated with a dry adhesive, and the cartridge 16 can be arranged to dispense water or other liquid substance for activating the adhesive on the fiber as it passes in the vicinity of the cartridge applicator tip 18. For routing over rough surfaces, the fiber 14 may include an outer foam layer in which the adhesive is impregnated and becomes subject to activation when a liquid is applied on the outer surface of the foam layer. Liquid activated adhesives are disclosed in, e.g., U.S. Pat. No. 7,235,608 (Jun. 26, 2007), No. 5,296,535 (Mar. 22, 1994), No. 4,719,264 (Jan. 12, 1988), No. 4,639,395 (Jan. 27, 1987), No. 4,575,525 (Mar. 11, 1986), No. 4,322,472 (Mar. 30, 1982), and No. 3,988,495 (Oct. 26, 1976), all relevant portions of which are incorporated by reference.

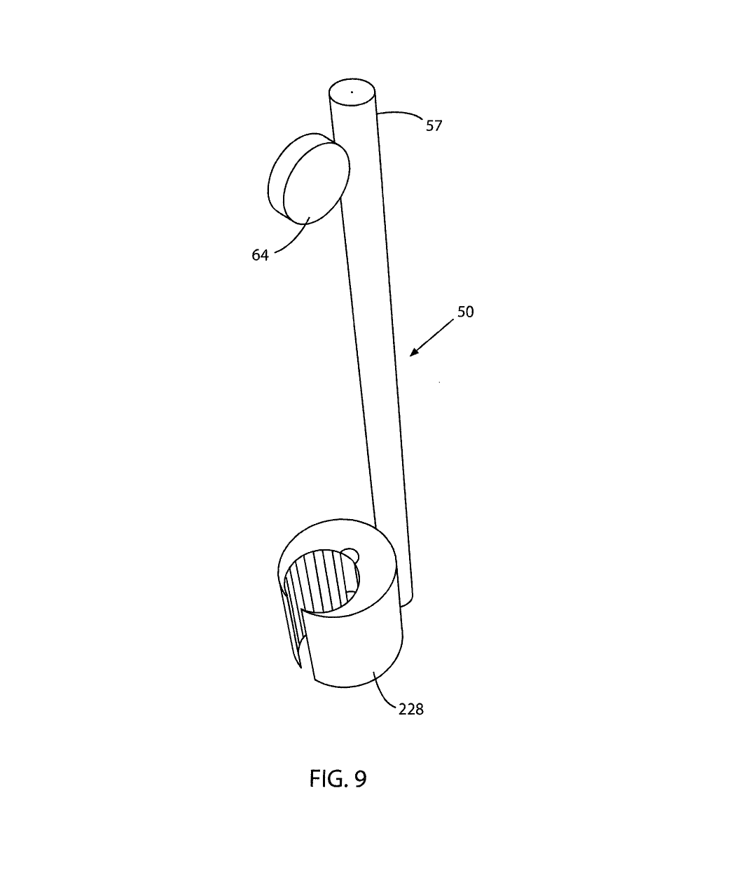

FIG. 2 shows a second embodiment of the invention. In FIG. 2, an applicator tool 50 is constructed generally the same or similar to a conventional fishing rod. A reel or spool 52 with a length of optical fiber 54 wound on the spool, is placed in a mount 53 near a proximal handle end of the tool 50. The mount 53 may be the same or similar to the mount 228 in FIG. 9, so that fiber 54 unwinds or pays out from the spool 52 while the fiber is being routed by the tool 50 over a desired span. The opposite ends of the fiber 54 may be unterminated, or terminated at one or both ends with specified connectors.

An advantage of the tool 50 in FIG. 2 is that it allows an installer to route the spooled fiber 54 on and along a high ceiling or other location while standing at a remote position, without the use of ladders or the need for additional assistance or personnel. One or more rings, loops, tubes, channels or equivalent guide elements 62 are preferably fixed along the length of the rod of the tool 50, to guide the fiber 54 safely toward the distal end 57 of the tool 50 as the fiber is unwound from the spool 52.

An adhesive coating assembly 56, including an associated adhesive applicator tube or passage 58 and an adhesive cartridge 60, are mounted on the applicator tool 50 downstream from the spool 52. The fiber 54 is guided to pass through the passage 58 after leaving the spool 52. The assembly 56 is operative to supply a determined amount of an adhesive substance from the cartridge 60 into the interior of the passage 58 as the fiber 54 moves through the passage, so that a thin coating of the adhesive is applied on the outside surface of the fiber 54.

Alternatively, and as described above in relation to the embodiment of FIG. 1, the fiber 54 may be pre-coated with a dry adhesive, and the assembly 56 may be configured to provide a determined amount of water or other liquid substance to activate the coating on the fiber as it moves through the applicator passage 58. The dry adhesive formulation should be selected so that when activated, it will provide satisfactory adhesion between the outer surface of the fiber 54 and the structural surface on which the fiber is being routed. The dry adhesive may also be formulated to work with an existing coating on the fiber, e.g., PVC, nylon, urethane, acrylate, or others. All process aids should be selected to optimize the adhesion of the fiber to the structural surface, or within the groove or channel in which the fiber will be recessed.

The applicator tool 50 preferably has a small wheel, roller, or other fiber routing applicator 64 disposed at the distal end 57 of the tool to aid the installer to position the coated fiber 54 accurately on a structural surface, and to urge the fiber against the surface so that the fiber will bond properly with the surface over the desired span. Further, a portion of the tool 50 between the handle and the distal end 57 may be made to telescope or be extendable, so that the installer can route the fiber over the desired span on the structural surface while holding the tool a distance away from the surface and while standing. A desired minimum bend radius of, e.g., 7 mm may be maintained for the fiber 54 using a conventional outside corner guide.

According to a third embodiment of the invention, a conventional adhesive transfer tape dispenser is loaded with a reel or spool containing a supply of adhesive tape. Before the tape is wound on the spool, an optical fiber or cable is adhered along the length of the tape, on either side of the tape. Alternatively, the dispenser may be constructed and arranged to pay out the adhesive tape and the fiber separately and simultaneously from two different spools. The tape and the fiber may then be guided from the spools to approach one another near the structural surface so that the tape overlies the fiber when the tape is adhered on the surface. Dual spool tape dispensers, such as, e.g., models ATG-700, -714 or -752 from 3M Company, or model H-1221 from ULINE, are presently available and may be modified accordingly in a known manner.

Either arrangement has the advantage that once the tape and the underlying fiber are applied by the dispenser along a wall, ceiling or other structural surface, the fiber will not become embedded in a caulking or adhesive material that would prevent the fiber from being removed safely after routing in a home or office environment. The grade of the adhesive tape may be selected according to the degree of permanency desired for the fiber installation.

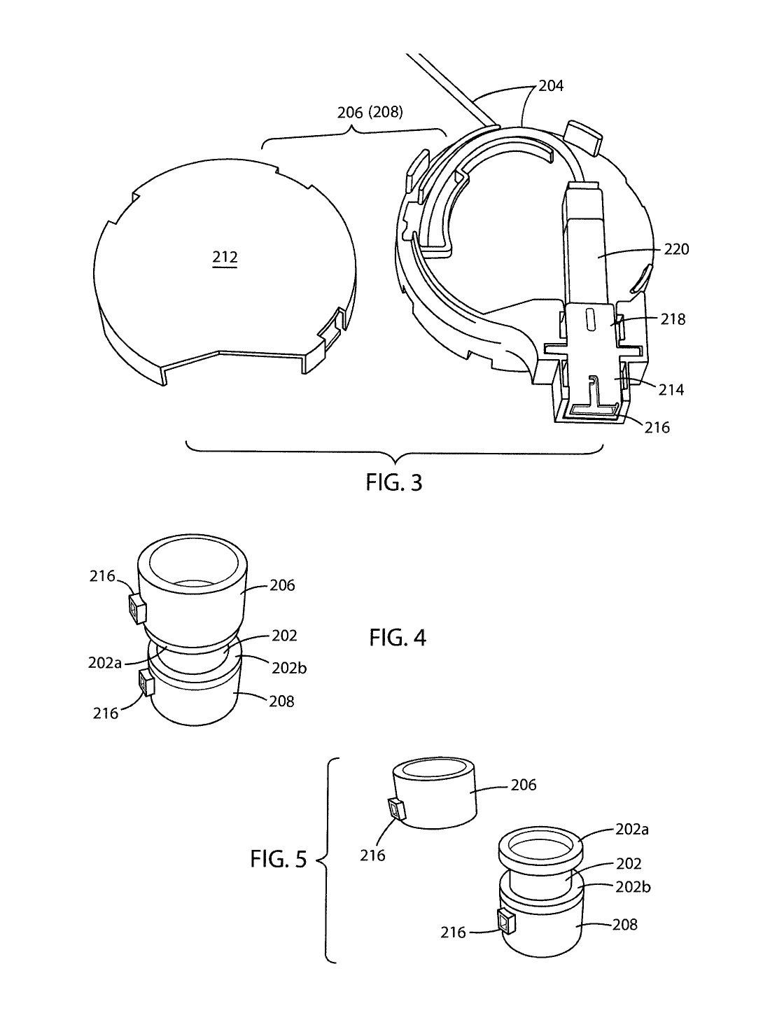

FIGS. 3 to 9 show a fiber or cable routing system 200 wherein the applicator tool 50 of FIG. 2 may be adapted to operate with a fiber storage spool 202 containing, e.g., about 75 to 100 feet of optical fiber or cable 204, and a pair of optical termination units or boxes 206, 208 (sometimes called “rosettes”) each of which is detachably fastened to a corresponding side wall or flange 202a, 202b of the spool 202. The fiber or cable 204 may comprise, for example, a single 900 μm fiber, 1.2 mm cordage, or optical bundles or ribbon, and have a connector such as, without limitation, type SC, LC, or MPO, provided at one or both ends of the cable. For typical applications, a fiber such as EZ-Bend® available from OFS Fitel, LLC, is preferred. EZ-Bend is an ultra bend insensitive fiber that can tolerate copper wire like installations in homes and multi-dwelling units (MDU). The fiber exhibits a macrobending loss of less than 0.1 dB (0.06 dB typical) at 1550 nm over a full turn with a radius of five mm or less.

The optical termination boxes 206, 208 may be commercially available units such as, e.g., type J424 or type J418 from OFS Fitel, LLC. One of the termination boxes 206, 208 is illustrated in FIG. 3 with a top cover plate 212 removed. Each box is typically molded from a plastics material such as PVC and includes a standard optical connector adapter 214, as shown in FIG. 3. The adapter 214 is mounted in the box so that so that a distal end 216 of the adapter is accessible from outside the box for connection with a mating connector at one end of, e.g., an incoming provider or drop cable, or a cable leading to user equipment such as a set top box, a communications modem, or the like. The proximal end 218 of the adapter 214 is accessible inside the box 206 for connection with a connector 220 that terminates a corresponding end portion of the spooled fiber 204. As seen in FIG. 3, the end portion of the fiber 204 may enter a lower compartment or other region of the box 206, and be guided over a partial or full circular path so as to maintain a minimum bend radius and provide strain relief for the fiber.

The fiber storage spool 202 and the termination boxes or rosettes 206, 208 may be fabricated and assembled in a factory environment, so that the installer only needs to:

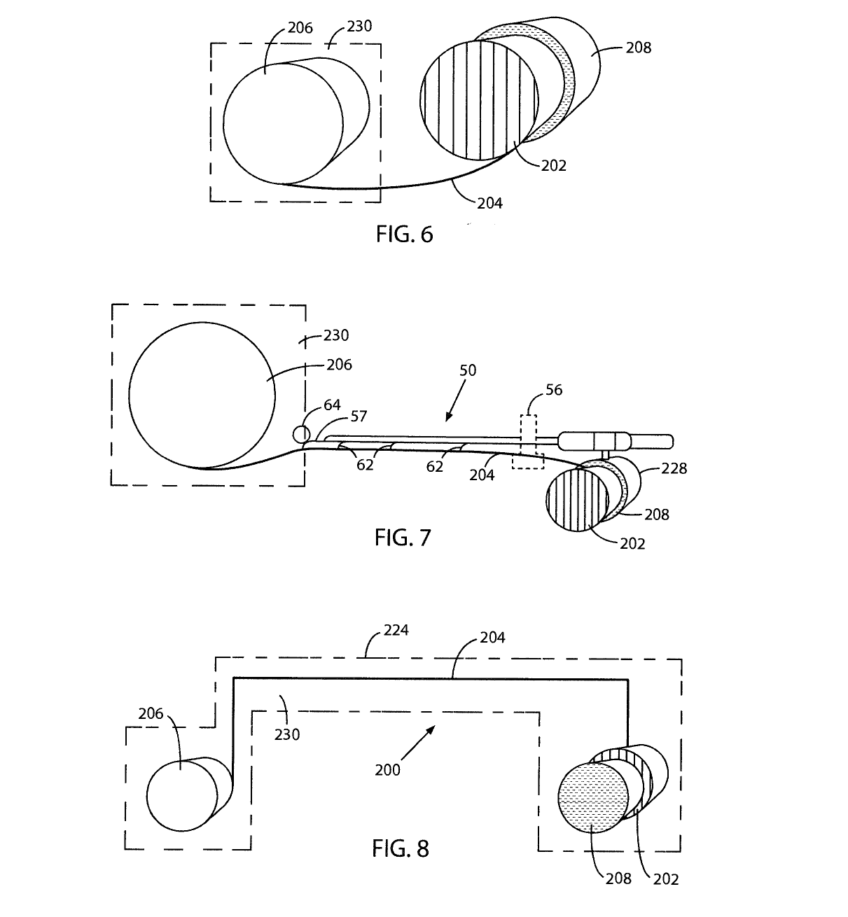

1. Detach one of the termination boxes (e.g., box 206) from the fiber storage spool 202, and attach the box at a first location (via a screw or other fastener) at or near one end of a span 224 over which the fiber 204 is to be routed on a structural surface 230. See FIGS. 6 and 8.

2. Load the other termination box 208 with the attached fiber storage spool 202 into a corresponding mount or cradle 228 on the application tool 50. See FIG. 9. The mount 228 is preferably constructed in a known manner so as to enable the box 208 and the spool 202 to rotate about a common spool axis as the fiber 204 unwinds from the spool. Alternatively and similar to the construction of a conventional spinning type fishing rod, the mount 228 may be arranged to retain the spool 202 and the box 208 in a fixed position, and to guide the fiber 204 to spin about the spool axis as the fiber leaves the spool during routing.

3. Route the fiber 204 over the desired path 224 on the structural surface 230 using the application tool 50. See FIGS. 7 and 8.

4. Remove the other termination box 208 and the storage spool 202 containing any remaining fiber 204 from the tool mount 228, and affix the box and spool at a second location at or near the opposite end of the span 224 over which the fiber was routed on the surface 230. See FIG. 8.

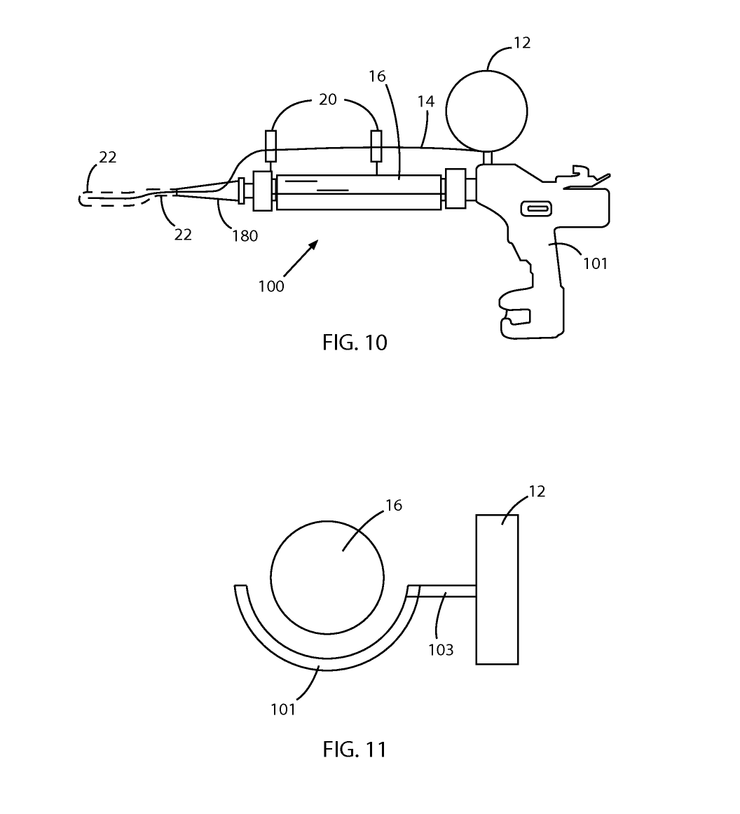

In FIG. 10, another tool 100 for routing an optical fiber or a cable over a desired span on a structural surface at a given premises is shown. The tool 100 includes a hand-held gun device 101, a spool 12, and an adhesive-containing cartridge 16 having a nozzle 180 disposed at its distal end. The nozzle 180 is sometimes referred to as a fiber-routing applicator. The cartridge 16 is mounted in the gun device 101. The gun device 101 is an adhesive-dispensing apparatus and may be a custom made device or an existing conventional mechanical or electrically powered caulking gun.

The cartridge 16 contains adhesive material 22 that is dispensed from the nozzle 180 at the distal end of the cartridge 16. The adhesive material 22 in the cartridge 16 may be a monomeric or polymeric caulking material containing acrylic, polyurethane, or silicone material. For example, suitable caulking materials include, but are not limited to, DAP® DYNAFLEX 230®Premium Indoor/Outdoor Sealant—Clear commercially available from DAP Products Inc. in Baltimore, Md., and Loctite POLYSEAMSEAL® ALL-PURPOSE Adhesive Caulk commercially available from Loctite in Westlake, Ohio.

The spool 12 contains a length of the optical fiber 14 to be routed over the desired span, and the spool 12 may be attached to the gun device 101 or to the cartridge 16. In FIG. 10, the spool 12 is mounted near a proximal trigger end of the gun device 101, so that the fiber 14 unwinds from the spool while it is being routed by the device over a desired span on a wall, ceiling, or other structural surface at a user's premises.

The spool 12 may be constructed and arranged in a known manner for easy mounting on the gun device 101, and for quick removal when the wound fiber 14 is exhausted or when another spool containing a different type of fiber or cable is desired. For example, as shown in FIG. 11, the spool 12 may be attached to the gun device 101 via a rod 103 that extends from the gun device 101. The fixture for mounting spool 12 on gun device 101 may allow spool 12 to be re-positioned on the gun device 10 prior to or during the installation process to bypass obstacles to the passage of the gun device 101/spool 12 assembly. Preferably, the spool 12 is detachably mounted on the gun device 101 for easy replacement. Also, the opposite ends of the fiber 14 may be unterminated, or terminated at one or both ends with specified connectors.

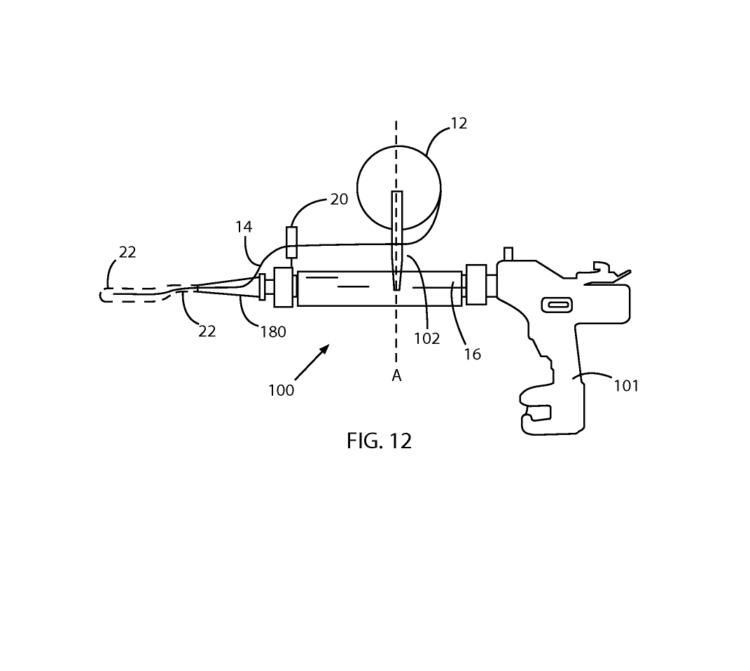

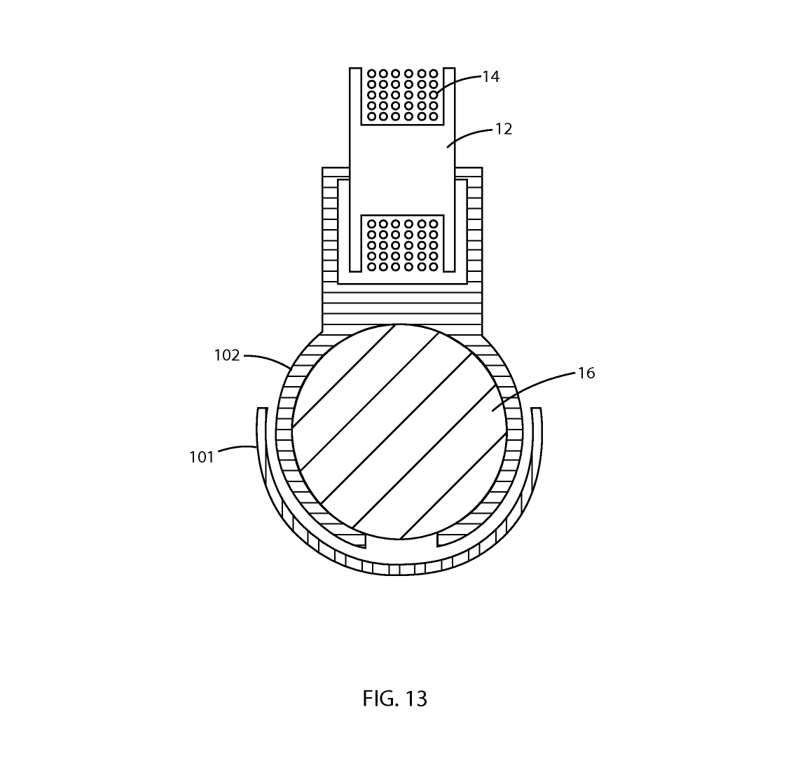

In FIG. 12, the spool 12 is mounted on the cartridge 16. The spool 12 may be constructed and arranged in any known manner for easy mounting on the cartridge 16, and for quick removal when the wound fiber 14 is exhausted or when another spool containing a different type of fiber or cable is desired. For example, a clamp 102 shown in FIG. 13 attaches the spool 12 to the cartridge 16. The clamp 102 is spring-loaded and is dimensioned such that it snaps onto the spool 12 and onto the cartridge 16, and may be made from metal or plastic. Preferably, the spool 12 is detachable from the replaceable cartridge 16 for easy replacement. Also, the opposite ends of the fiber 14 may be unterminated, or terminated at one or both ends with specified connectors.

Referring back to FIG. 10, the fiber-routing applicator 180 is disposed at the distal end of the cartridge 16. The applicator 180 is configured to receive the optical fiber 14 from the spool 12 and to dispense both adhesive material 22 and fiber 14 simultaneously as the applicator 180 travels over the desired span. Preferably, one or more guide elements 20 are fixed along the length of the gun device 101 for guiding the fiber 14 from the spool 12 toward the fiber-routing applicator 180. The fiber-routing applicator 180 is dimensioned and arranged to travel over the structural surface, and to route the fiber 14 with the adhesive material 22 thereon over the desired span while urging the fiber 14 against the surface so that the fiber 14 adheres to the surface.

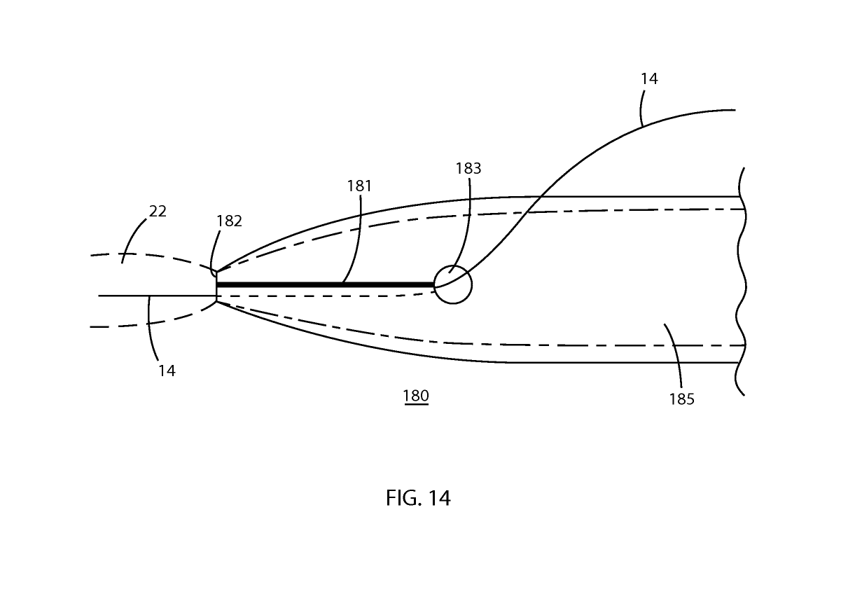

In FIG. 14, an embodiment of the nozzle 180 is shown. The nozzle 180 includes a hollow passageway 185 that extends axially along its length, and a slot 181 that extends from an outside surface of the nozzle 180 into the hollow passageway 185 along a portion of the nozzle 180 for receiving the optical fiber 14.

Preferably, the nozzle 180 includes a hole 183 that is positioned at one end of the slot 181 for receiving the optical fiber 14, the diameter of the hole 183 being larger than the width of the slot 181, and the width of the slot 181 being narrower than the diameter of the fiber 14 such that fiber 14 pressed into the hollow passageway 185 is retained within the passageway 185 as the adhesive material 22 and the fiber 14 are simultaneously dispensed.

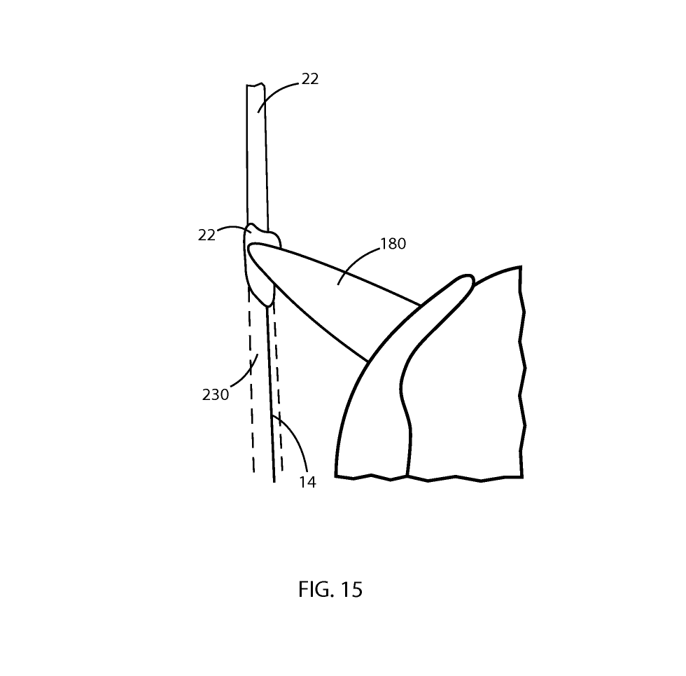

Preferably, as shown in FIG. 15, the nozzle 180 places the fiber 14 underneath a portion of the adhesive material 22 while urging the fiber 14 against the structural surface 230 so that the fiber 14 adheres to the surface 230.

The nozzle 180 at the distal end of the cartridge 16 may be use directly to dispense adhesive material and fiber simultaneously. However, a second nozzle 280 that attaches to the first nozzle 180 may be used. Such a design has the advantage that its slot and hole are already molded into the nozzle 280.

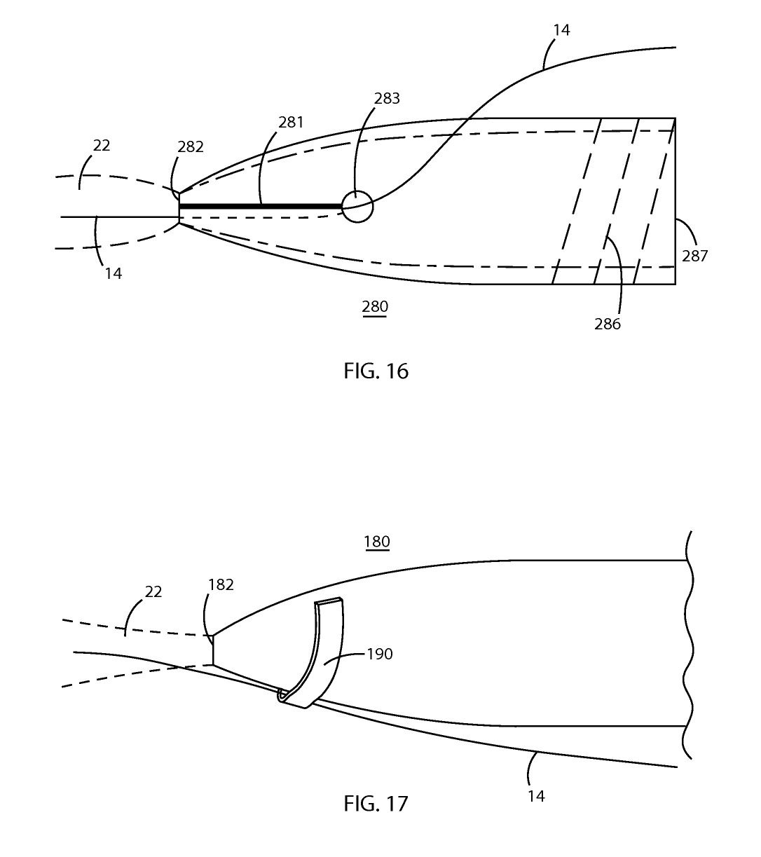

In FIG. 16, an embodiment of the second nozzle 280 is shown. Any suitable means may be used to attach the second nozzle 280 to the first nozzle 180 of the cartridge 16. The first nozzle 180 may or may not have the slot 181 or the hole 183. One example of such means is an inner thread 286 placed at proximal end 287 of the second nozzle 280. When the second nozzle 280 is attached to the first nozzle 180 and screwed, an inner thread 286 creates a tight bond between the first and second nozzles 180 and 280.

Preferably, at least the thickness of the second nozzle 280 near the distal end (where the tip 282 is located) of the second nozzle 280 is sufficient to avoid widening the slot 281 when the pressure from dispensing the adhesive or caulking material 22 is present. A locking ring consisting of a C-shaped open ended clamp may be placed over the nozzle to prevent the fiber from exiting the slot. The nozzle may include protruding tabs or ridges to guide the locking ring in place.

The second nozzle 280 can also be attached to a first nozzle 180 at the distal end of a squeezable cartridge, i.e., one that does not require a gun device to dispense the adhesive material within the cartridge.

Alternatively, a guide clamp 190 may be attached to the first nozzle 180 of the cartridge as shown in FIG. 17. The guide clamp 190 is placed proximate to the tip 182 of a cartridge inserted into a gun device or a squeezable tube. The guide clamp 190 retains the fiber 14 in such way that the fiber 14 is placed within the adhesive material 22 as the adhesive material 22 and the fiber 14 are simultaneously dispensed. Preferably, as shown in FIG. 15, the fiber-routing applicator 180 places the fiber 14 underneath the adhesive 22 while urging the fiber 14 against the structural surface 230 so that the fiber 14 adheres to the surface 230.

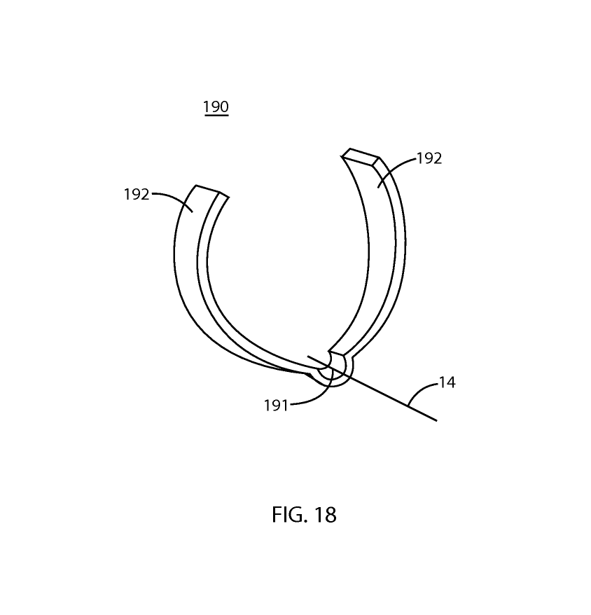

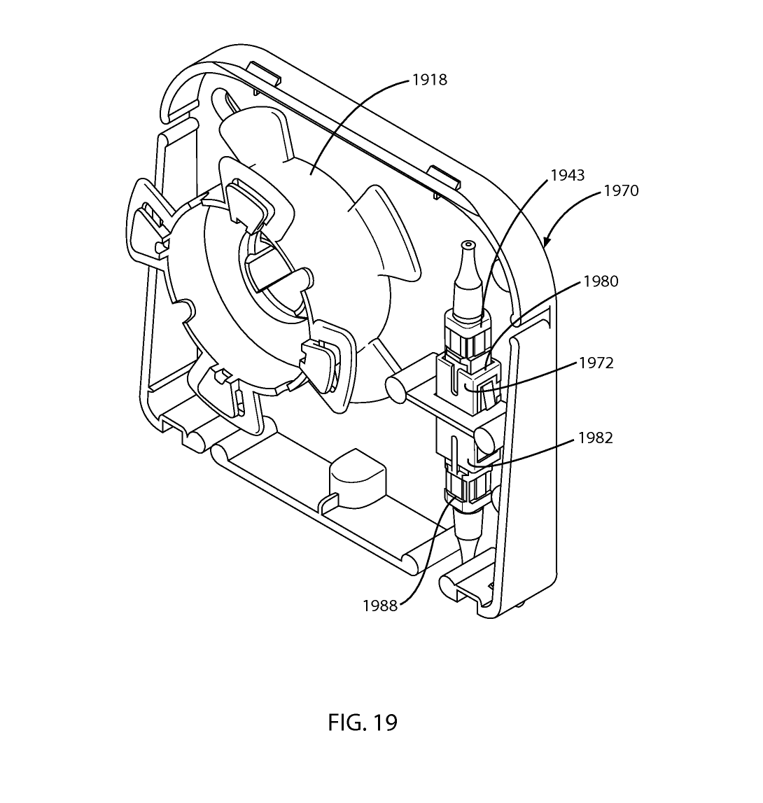

In FIG. 18, an embodiment of the guide clamp 190 is shown. The guide clamp 190 has a fiber guide 191, which is configured to receive the fiber 14 from the spool and to enable both adhesive material and fiber 14 to be dispensed simultaneously as the nozzle 180 travels over the desired span. The arms 192 are spring-loaded and dimensioned such that they snap onto the first nozzle 180 and place the guide clamp 190 relatively on the same position with respect to the cartridge. The guide clamp 190 is detachable from the nozzle 180 of the cartridge for easy replacement.

Referring back to FIG. 10, the fiber 14 may have, for example but not be limited to, a clad outer diameter of 50 μm to 1000 μm, or a coating outer diameter of 55 μm to 2000 μm, or a tight-buffered outer diameter of 100 μm to 3000 μm. In addition, the fiber 14 may be in the form of a cordage, and the diameter of the cordage is between 60 μm to 10 mm. Preferably, the fiber 14 is a ultra bend-insensitive fiber, which exhibits a macrobending loss of less than 0.2 dB at 1550 nm when the fiber 14 is wrapped around a circular rod with a radius of 5 mm. Also, the optical fiber may be within optical-fiber-containing structure such as a fiber-ribbon, a loose tube cable or a slotted core cable.

Due to the growing demand for higher speed information transfer at home and business locations, it has become increasingly desirable to add optical fiber to the interior space of an existing structure without intruding into its walls, ceiling or floor. Moreover, it is desirable that such fiber be nearly invisible after installation to preserve aesthetic appearance. Finally, it is desirable that installation be possible by a single craftsman who may need to attach the fiber to a ceiling (generally the junction between the ceiling and a wall), which may require that a ladder be used during the installation process, and that the fiber remain attached to the ceiling as the craftsman repositions the ladder. The following methods substantially satisfy the above-stated desires:

An optical fiber or cable may be routed over a desired span on a structural surface in a room or office in multiple steps. For example, a bead of adhesive material may be applied to at least a portion of a desired span on a structural surface, then a length of an optical fiber or cable stored in a container is removed from the container and pressed into the bead of adhesive material such that the fiber adheres to the surface.

Alternatively, a length of an optical fiber or cable stored in a container may be removed from the container and attached to a structural surface at two or more points along a desired span of the structural surface. Then a bead of adhesive material is applied to the optical fiber between the point of attachment such that the fiber adheres to the surface. For example, staples or tape may be used to temporarily attach the fiber to the structural surface, which then may be removed after the bead of adhesive material has been applied,

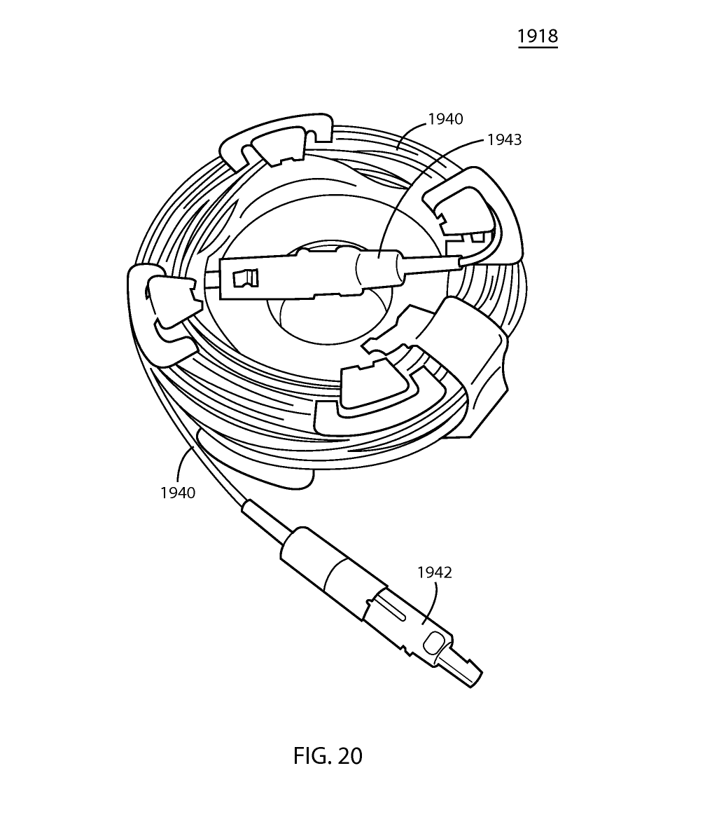

Alternatively, optical fiber may be stored within a fiber storage module and then routed along a desired path on a structural surface between first and second locations. For example, the fiber storage module shown in FIG. 19 may be used. The fiber storage module 1970 includes a spool 1918. As shown in FIG. 20, the spool 1918 is configured to store optical fiber 1940. The optical fiber 1940 is terminated at each end with an optical connector 1942 and 1943. Preferably, the first optical connector 1942 is placed at the circumference of the spooled fiber 1940 and the second optical connector 1943 is placed at the center of the spool 1918 such that when the optical fiber 1940 is unwound from the first optical connector 1942 end, the optical fiber 1940 pays out smoothly and does not tangle inside the module 1970. Furthermore, the spool 1918 may be detachable from the fiber storage module 1970.

Referring back to FIG. 19, the fiber storage module 1970 further includes an optical connector adapter 1972 inside the module 1970. The proximal end 1980 of the adapter 1972 is configured to mate with the second optical connector 1943 at the end of the fiber 1940 in FIG. 19. A distal end 1982 of the adapter 1972 is configured to mate with an optical connector 1988 at one end of a jumper cable (not shown) that leads to a customer's Optical Network Terminal inside a premise.

Optical fiber 1940 may be routed along a desired span on a structural surface between first and second locations within a building or living unit using the fiber storage module 1970. One exemplary routing method starts with the fiber storage module 1970 storing the optical fiber 1940. When the optical fiber 1940 is stored, the fiber 1940 is wound on the spool 1918 and terminated at each end with an optical connector 1942 and 1943.

Then, connector 1942 is positioned at the first location for connection to a source of incoming optical signals. When the connector 1942 is positioned at the first location, it may be connected to an adapter located at the first location. Alternatively, the connector 1942 may be placed near the adapter and connected thereto after the fiber 1940 is routed.

A bead of adhesive material is applied to at least a portion of a desired span on a structural surface between the first and second locations, and a length of an optical fiber 1940 stored in the fiber storage module 1970 is removed from the module 1970 and pressed into the bead of adhesive material such that the fiber adheres to the surface. Then, the fiber storage module 1970 is attached to a surface at the second location within the building or living unit.

Preferably, the adhesive material is substantially translucent when it is applied. Alternatively, the adhesive material becomes substantially translucent within 24 hours after it is applied.

Preferably, the optical fiber 1940 is a buffered optical fiber that is substantially bend-insensitive and can accommodate a bend radius as small as 3 mm without significant signal loss.

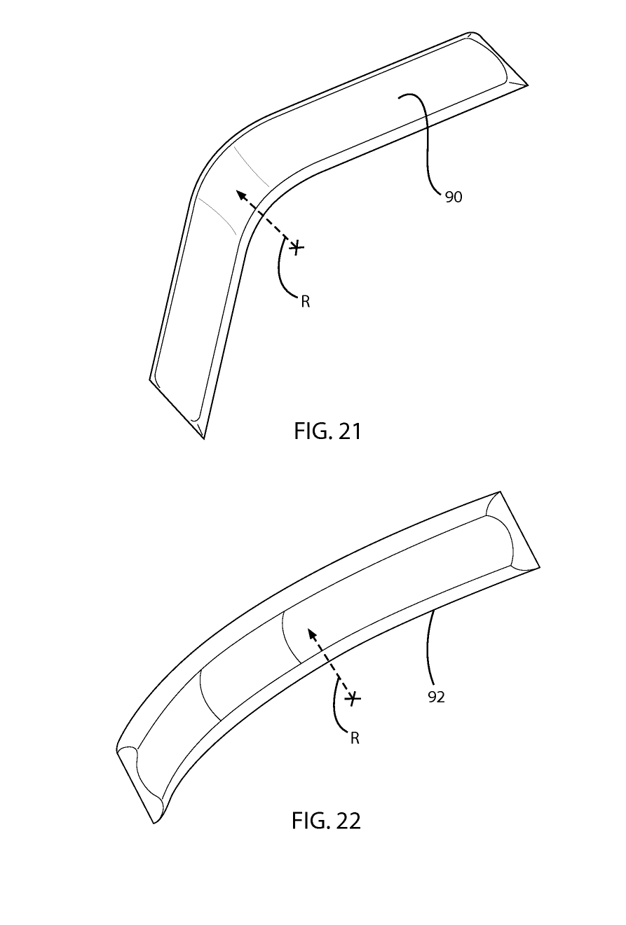

In addition, when the fiber 1940 is routed around right angle corners during the installation, first or second bend managers 90 or 92 may be used. The first bend manager 90 shown in FIG. 21 is used when the fiber is routed outside of a right-angle corner. The second bend manager 92 shown in FIG. 22 is used when the fiber is routed inside of a right-angle corner.

Additional explanation of the fiber storage module 1970 and the bend managers 90 and 92 are disclosed in co-pending PCT Application No. PCT/11/44419 filed on Jul. 19, 2011, entitled “OPTICAL FIBER INSTALLATION AT CUSTOMER PREMISES”, which is owned by the assignee of the present application, and which is incorporated herein by reference in its entirety.

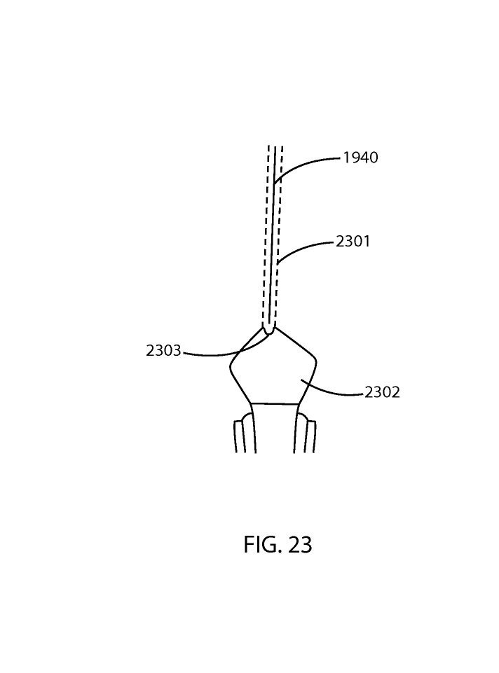

As shown in FIG. 23, when the unwound fiber 1940 is pressed into the bead of adhesive material 2301, a caulk finishing tool 2302 may be used. The caulk finishing tool 2302 has a groove 2303 at the tip of the tool 2302 such that the tool 2302 guides the fiber 1940 and keeps the fiber 1940 straight as the tool 2302 presses the fiber 1940 into bead of adhesive material 2301.

As disclosed herein, an optical fiber or cable is routed over a desired span on a structural surface in a room or office, using a limited amount of hardware and with a minimal form factor to avoid creating unsightly marks along the surface. By selecting an appropriate adhesive, the fiber can be adhered on or recessed within most surfaces normally encountered in residential and commercial living units, namely; wallpaper, sheet rock, painted surfaces, and more durable surfaces such as cement, stone, and marble.

While the foregoing represents preferred embodiments of the invention, it will be understood by those skilled in the art that various modifications and changes may be made without departing from the spirit and scope of the invention, and that the invention includes all such modifications and changes as come within the scope of the following claims.

Although the specification discussed methods of routing an optical fiber over a desired span on a structural surface inside a building or living unit, in one particular sequence, the specification did not directly or implicitly require a particular order in routing the fiber. The language of the method claims does not impose a specific order on the performance of the method steps, and the steps can be performed in different order without exceeding the scope of the claim(s).

We claim:

1. A method for routing an optical fiber over a desired span on a structural surface inside a building or living unit, the method comprising the steps of:
applying an adhesive material directly onto the desired span;
pressing a portion of the optical fiber into the adhesive material.

2. The method of claim 1 wherein the optical fiber is a buffered optical fiber having an outer diameter of smaller than approximately 3 mm.

3. The method of claim 1 wherein the optical fiber is within an optical cable.

4. The method of claim 3 wherein the diameter of the optical cable is 900 μm.

5. The method of claim 1 wherein the optical fiber is substantially bend-insensitive, and capable of accommodating a bend radius as small as 3 mm without significant signal loss.

6. The method of claim 5 wherein the optical fiber is an ultra bend-insensitive fiber, which exhibits a macrobending loss of less than 0.2 dB at 1550 nm when the fiber is wrapped around a circular rod with a radius of 5 mm.

7. The method of claim 5 wherein the optical fiber is a G657.B3 fiber.

8. The method of claim 1 wherein the adhesive is directly in contact with the optical fiber.

9. The method of claim 1 wherein the adhesive material comprises acrylic, silicone, or polyurethane caulking material.

10. The method of claim 1 wherein the adhesive material is substantially translucent when applied.

11. The method of claim 1 wherein the adhesive material becomes substantially translucent within 24 hours.

12. The method of claim 1 further comprising a step of applying an outside bend manager on the structural surface when the fiber is routed outside of a right-angle corner.

13. The method of claim 1 further comprising a step of applying an inside bend manager on the structural surface when the fiber is routed inside of a right-angle corner.

14. A method for routing an optical fiber over a desired span on a structural surface inside a building or living unit, the method comprising the steps of:
attaching a portion of the optical fiber to the structural surface at two or more points along the desired span; and
applying an adhesive material to a portion of the optical fiber between the points of attachment.

15. The method of claim 14 wherein staples are used for attachment.

16. The method of claim 14 wherein tape is used for attachment.

17. The method of claim 14 wherein the optical fiber is a buffered optical fiber having an outer diameter of smaller than approximately 3 mm.

18. The method of claim 14 wherein the optical fiber is within an optical cable.

19. The method of claim 18 wherein the diameter of the optical cable is 900 μm.

20. The method of claim 14 wherein the optical fiber is substantially bend-insensitive, and capable of accommodating a bend radius as small as 3 mm without significant signal loss.

21. The method of claim 20 wherein the optical fiber is an ultra bend-insensitive fiber, which exhibits a macrobending loss of less than 0.2 dB at 1550 nm when the fiber is wrapped around a circular rod with a radius of 5 mm.

22. The method of claim 20 wherein the optical fiber is a G657.B3 fiber.

23. The method of claim 14 wherein the adhesive is directly in contact with the optical fiber.

24. The method of claim 14 wherein the adhesive material comprises acrylic, silicone, or polyurethane caulking material.

25. The method of claim 14 wherein the adhesive material is substantially translucent when applied.

26. The method of claim 14 wherein the adhesive material becomes substantially translucent within 24 hours.

27. The method of claim 14 further comprising a step of applying an outside bend manager on the structural surface when the fiber is routed outside of a right-angle corner.

28. The method of claim 14 further comprising a step of applying an inside bend manager on the structural surface when the fiber is routed inside of a right-angle corner.
